(19) United States
(12) Patent Application Publication
(10) Pub. No.: US 2025/0386198 A1
(43) Pub. Date: Dec. 18, 2025

(54) Encrypted Smart Eyeglass Tracking System

(71) Applicant: Lawrence Brandon Smith, III, Houston, TX (US)

(72) Inventor: Lawrence Brandon Smith, III, Houston, TX (US)

(73) Assignee: Lawrence Brandon Smith III, Houston, TX (US)

(21) Appl. No.: 19/236,568

(22) Filed: Jun. 12, 2025

Related U.S. Application Data
(60) Provisional application No. 63/659,645, filed on Jun. 13, 2024.

(51) Int. Cl. H04W 12/64; H04W 4/029; H04W 4/80; H04W 12/06; H04W 12/08

(52) U.S. Cl. CPC H04W 12/64; H04W 4/029; H04W 4/80; H04W 12/06; H04W 12/08

(57) ABSTRACT

Embodiments of the present invention provide a smart eyeglasses comprising an embedded tracking module comprising Bluetooth Low Energy (BLE), Global Positioning System (GPS), Ultra-Wideband (UWB), and Near Field Communication (NFC) components. The system enables real-time and passive location tracking, proximity detection, reverse search, and recovery assistance via a mobile application. The eyeglass communicates bi-directionally with a mobile device and can pair with smart home systems for voice or digital location commands. The mobile application provides visual indicators of device status and enables shared tracking access with secondary users under defined permissions. The invention is applicable for personal, enterprise, or defense use cases, offering discreet, modular integration with standard eyeglass frames.

### CROSS-REFERENCE TO RELATED APPLICATIONS

The present non-provisional application claims the benefit of priority to provisional patent application No. 63/659,645, filed Jun. 13, 2024, entitled METHOD, DEVICE, AND SYSTEM FOR CONTROL TRACKING OF TRACKABLE DEVICES.

### FIELD OF THE INVENTION

The present invention relates to the field of a smart eyeglass system, and more particularly to a system for tracking, locating, and managing the eyeglass.

### BACKGROUND OF THE INVENTION

Eyeglasses are essential accessories used by a wide range of individuals for vision correction, sun protection, or fashion purposes. Due to their frequent use and compact form factor, eyeglasses are prone to being misplaced, lost, or stolen, often leading to inconvenience or financial loss for the user. Various approaches have been developed to address the issue of locating lost personal items, including standalone tracking tags that can be attached to objects and paired with a mobile phone. However, these solutions typically require external accessories that can be bulky, aesthetically intrusive, or easily detached.

Efforts have been made to embed tracking technologies into wearable products such as watches or fitness bands. However, integrating such technologies into eyeglass frames, particularly the temple wires, poses unique design challenges due to spatial constraints, weight distribution, and the need to maintain user comfort and aesthetics. Moreover, conventional tracking systems are often limited to unidirectional communication, provide imprecise location updates, or lack contextual awareness in indoor environments. Additionally, existing systems generally do not support shared access, multi-device interoperability, or integration with smart home ecosystems.

There remains a need for an unobtrusive, embedded tracking solution for eyeglasses that provides high-precision localization, real-time bi-directional communication, and enhanced usability through mobile and smart home platforms. The system should allow for customizable alert settings, reverse search capability (where the wearable device can locate the user's phone or other connected devices), tamper-aware recovery processes, and efficient power management.

The present invention addresses these limitations and introduces a modular eyeglass with integrated tracking, communication, and power features that facilitate accurate and convenient location-based services, device recovery, and user-centric control through digital platforms.

### OBJECTS OF THE INVENTION

The primary object of the present invention is to provide a smart eyeglass integrated with tracking and communication functionalities, capable of being embedded within or attached to an eyeglass frame in a manner that is aesthetically unobtrusive and ergonomically compatible with everyday use.

Another object of the invention is to enable real-time tracking and localization of the eyeglasses through a combination of wireless technologies, including but not limited to Bluetooth Low Energy (BLE), Global Positioning System (GPS), Ultra-Wideband (UWB), and Near Field Communication (NFC), for both indoor and outdoor environments.

It is yet another object of the invention to facilitate secure pairing between the eyeglass and a companion mobile application, allowing the user to configure, monitor, and manage the device remotely through a graphical user interface.

Yet another object is to provide bi-directional communication between the smart eyeglass and a central user device, such as a smartphone or tablet, thereby enabling not only the ability to locate the eyeglass from the user device but also to initiate a reverse search wherein the eyeglass can trigger alerts to locate the user device or other paired accessories.

Another object of the invention is to support shared access and multi-user tracking by allowing a primary user to grant, manage, or revoke location access to secondary users under defined permissions, including time-bound or geo-fenced constraints.

Yet another object of the invention is to enable voice or digital command-based integration with smart home systems (e.g., Alexa, Google Home), allowing the user to track the eyeglasses using home network-connected devices.

It is an additional object of the invention to implement context-aware power management techniques, including but not limited to adaptive sleep-wake cycles, low-power BLE broadcasting, and location-based state transitions, for prolonging battery life.

Another object of the invention is to incorporate tamper-evident and user-assisted recovery features, such as NFC-triggered return request mechanisms and secure communication channels for lost-and-found scenarios.

It is a still further object of the invention to provide a modular architecture for the temple wire, enabling flexible configuration, integration with third-party eyewear frames, and scalable deployment across consumer, enterprise, and military use cases.

### SUMMARY OF THE INVENTION

According to a first aspect of the present invention, a system for tracking an eyeglass is provided. The system comprising: a communication module in the eyeglass configured to wirelessly communicate with a user device over a network, wherein the communication module operates on an encrypted communication protocol to prevent unauthorized access; a tracking module in the eyeglass configured to determine a location data of the eyeglass; a mobile application in the user device in communication with the communication module over the encrypted wireless network, the mobile application is configured to: receive an input from a user defining one or more exclusion zones; store the exclusion zone in association with a user account; retrieve a current location of the eyeglass; suppress a separation alert if the location is within an exclusion zone, and generate and transmit a separation alert if the location is outside all exclusion zones.

In one embodiment of the invention, the mobile application in the user device comprises a permission management subsystem configured to: receive an authorization input from a primary user to share location access with a secondary user; verify and store access credentials for the secondary user; enforce access control rules based on the stored permissions; and transmit tracking data to authorized users only.

In one embodiment of the invention, the mobile application is further configured to allow the user to modify, delete, or add exclusion zones in real-time, and dynamically applies the changes to the notification logic.

In one embodiment of the invention, the permissions management subsystem is configured to allow a primary user to set constraints for a secondary user including time-based access, geographic access limitations, or conditional usage rules.

In one embodiment of the invention, the tracking module includes at least one of a GPS receiver, UWB transceiver, inertial sensor, or Wi-Fi-based location system.

In one embodiment of the invention, the communication module is configured to operate over an encrypted wireless connection, and wherein the system prevents communication with unauthorized devices through encryption keys and authentication protocols.

In one embodiment of the invention, the system further comprising a cloud-based server configured to store exclusion zones and permissions data, and to synchronize said data across multiple devices associated with a same user account.

According to a second aspect of the present invention, a system for tracking an eyeglass is provided. The system comprising: a communication module in the eyeglass configured to wirelessly communicate with a user device over a network, wherein the communication module operates on an encrypted communication protocol to prevent unauthorized access; a tracking module in the eyeglass configured to determine a location data of the eyeglass; wherein the user device is configured to: execute a mobile application for receiving input from a user; receive signal data and the location data from the tracking module; wherein the mobile application is configured to: monitor co-location events between the eyeglass and an unregistered user device not associated with a registered owner of the eyeglass; determine that the eyeglass has maintained repeated or prolonged proximity to the unregistered user device over a defined time period exceeding a tacking concern threshold; generate a notification on the mobile application indicating potential unauthorized tracking by the unregistered user device.

In one embodiment of the invention, the mobile application in the user device generates and displays a navigational route to a current or last known location of the eyeglass based on the received location data.

In one embodiment of the invention, the tracking module includes at least one of a GPS receiver, a UWB transceiver, an inertia sensor, or Wi-Fi Wi-Fi-based location service.

In one embodiment of the invention, the communication module is configured to pair with a smart home system to receive a command to initiate a location alert.

According to a third aspect of the present invention, a system for tracking an eyeglass is provided. The system comprising: a temple wire configured to connect to an eyeglass frame, the temple wire comprising: a housing; a communication module embedded within the housing, the communication module configured to interface with a mobile application on a user device; a tracking module embedded within the housing, wherein the tracking module is configured to transmit location and proximity signals to a mobile application executable on a user device; wherein the mobile application is configured to: display a visual notification of a last known or current location of the eyeglass; and trigger an alert if the tracking module moves out of range.

In one embodiment of the invention, the temple wire is configured to pair with a smart home system to receive a command to initiate a location alert.

In one embodiment of the invention, the communication module includes at least Bluetooth, Bluetooth Low energy, Wi-Fi, cellular mode, or a combination thereof.

In one embodiment of the invention, the tracking module includes at least a GPS, a UWB transceiver, GNSS, a location-based Wi-Fi, or a combination thereof.

In one embodiment of the invention, the UWB transceiver is configured to communicate with an external access system, wherein the eyeglass is operable to authenticate and unlock a secure entry point upon detection of proximity between the UWB transceiver and a corresponding UWB receiver integrated into the external access system.

In one embodiment of the invention, the unlock event is triggered based on predefined signal strength thresholds, spatial orientation, or motion patterns as determined by one or more sensors on the eyeglass.

In one embodiment of the invention, the housing further comprises a tamper detection module configured to initiate an alert on the user device upon unauthorized removal or manipulation of the housing.

In one embodiment of the invention, the eyeglass comprises a pair of temple wires, wherein the communication module in a first temple wire is configured to pair with a first tracking network on the user device, and the communication module in a second temple wire is configured to pair with a second tracking network on the user device.

In one embodiment of the invention, the first tracking network and the second tracking network comprise Apple Find My Device and Google Find My Device.

In the context of the specification, the term “Temple wire” refers to the arm or side piece of an eyeglass frame, which extends from the lens frame and rests over the wearer's ear. In the context of the present invention, the temple wire includes a housing for embedding electronic components.

In the context of the specification, the term “Smart temple wire” or “smart eyeglass temple wire” refers to a temple wire integrated with electronic circuitry and tracking modules for enhanced functionality, including wireless communication, location tracking, and user interaction.

In the context of the specification, the term “Tracking module” refers to a subsystem embedded within the temple wire housing that includes one or more of: a GPS receiver, a Bluetooth Low Energy (BLE) module, an Ultra-Wideband (UWB) transceiver, and optionally an inertial measurement unit (IMU) or Near Field Communication (NFC) tag.

In the context of the specification, the term “BLE” or “Bluetooth Low Energy” is a wireless communication protocol designed for low power consumption, used for pairing and transmitting data between the temple wire and a user device (e.g., smartphone, tablet, or smart home hub).

In the context of the specification, the term “UWB” or “Ultra-Wideband” refers to a short-range radio technology capable of high-precision distance measurements and relative positioning between two devices.

In the context of the specification, the term “GPS receiver” refers to a satellite-based geolocation module integrated into the temple wire to provide global positioning data.

In the context of the specification, the term “Mobile application” or “tracking app” refers to a software application installed on a user device that communicates with the smart temple wire, enabling tracking, status monitoring, reverse search, and user settings management.

In the context of the specification, the term “Smart home system” refers to a networked environment comprising smart speakers, hubs, and appliances capable of receiving digital or voice commands. In this invention, the smart home system may be used to locate the temple wire via voice prompts such as “Hey Alexa, where are my glasses?”

In the context of the specification, the term “Reverse search” refers to functionality where the temple wire initiates a signal toward the user device or smart home hub to assist in locating the device (e.g., phone, tablet), thereby enabling bidirectional locating capability.

In the context of the specification, the term “Exclusion zone” refers to a geographic area predefined by the user (e.g., home or office) where loss alerts are suppressed, recognizing it as a safe location.

In the context of the specification, the term “Safe zone” is used interchangeably with “exclusion zone” to define areas in which loss tracking is deactivated or minimized.

In the context of the specification, the term “Primary user” refers to the person who initially configures and pairs the smart temple wire and owns the associated account on the tracking app.

In the context of the specification, the term “Secondary user” refers to an authorized individual with whom the primary user has shared access to the location data of the smart temple wire, governed by permission settings such as time, location, or usage limits.

In the context of the specification, the term “Tamper detection” refers to mechanisms, such as embedded sensors or circuit interruptions, configured to alert the user if the temple wire is removed, opened, or manipulated outside of predefined conditions.

In the context of the specification, the term “Power management module” refers to the circuitry or firmware responsible for optimizing battery usage in the smart temple wire, including transitions between sleep mode and active tracking mode.

In the context of the specification, the term “User device” refers to any portable electronic device capable of wireless communication, such as a smartphone, smartwatch, or tablet, used for interacting with the smart temple wire system.

In the context of the specification, the term “Communication link” refers to any wireless data connection, including but not limited to BLE, UWB, Wi-Fi, or cellular, established between the temple wire and a user or cloud system.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

### BRIEF DESCRIPTION OF THE DRAWINGS

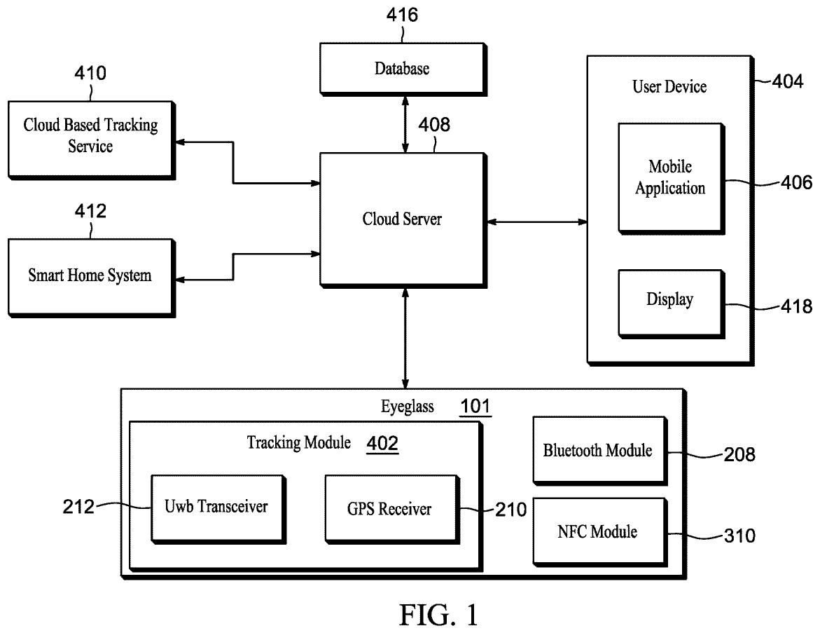

FIG. 1 is a block diagram of the system used for tracking the temple wire, in accordance with an embodiment of the present invention

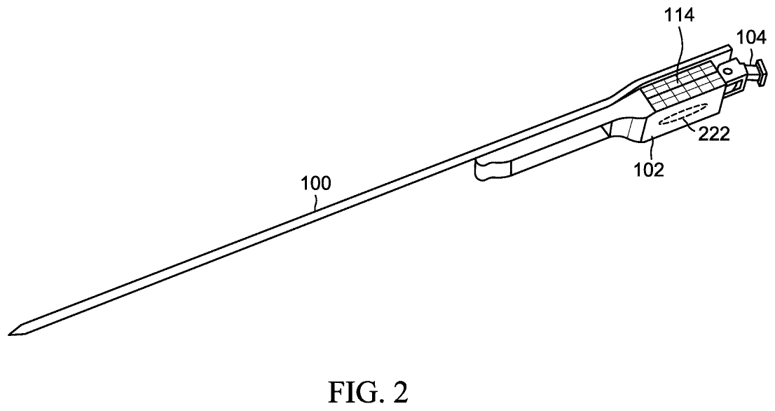

FIG. 2 shows a perspective view of a temple wire for an eyeglass frame, in accordance with an embodiment of the present invention.

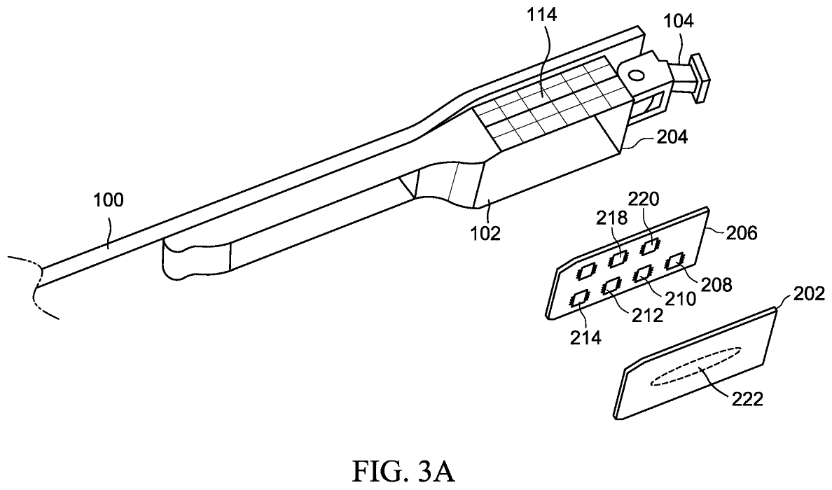

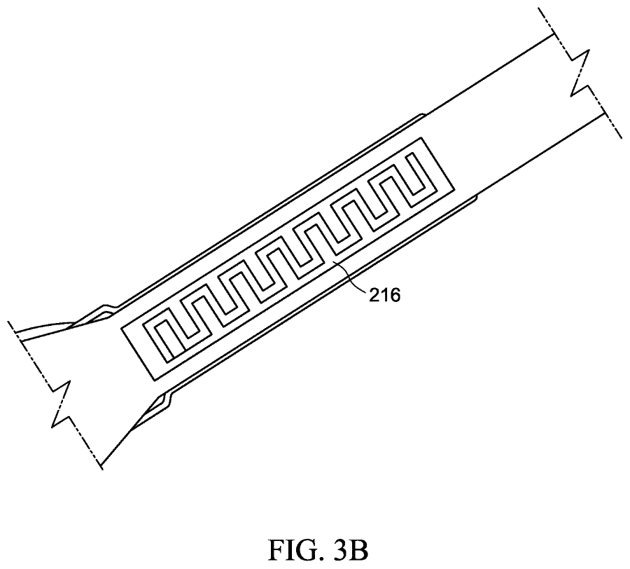

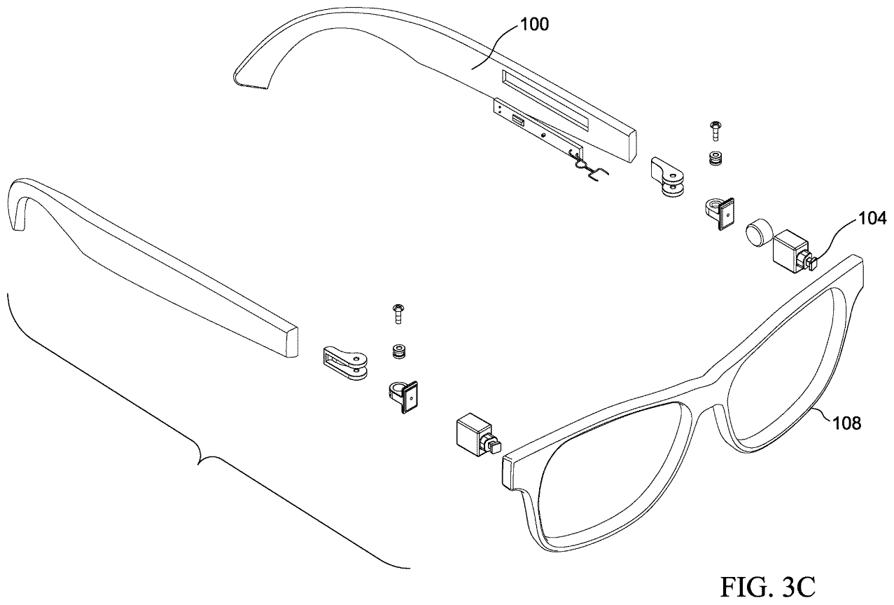

FIG. 3A shows an exploded view of the temple wire, in accordance with an embodiment of the present invention.

FIG. 3B shows arrangement of one or more Bluetooth antenna on the temple wire, in accordance with an embodiment of the present invention.

FIG. 3C shows an arrangement of the temple wire on the eyeglass, in accordance with an embodiment of the present invention.

FIG. 4 is a block diagram showing components of embedded electronics in the temple wire, in accordance with an embodiment of the present invention.

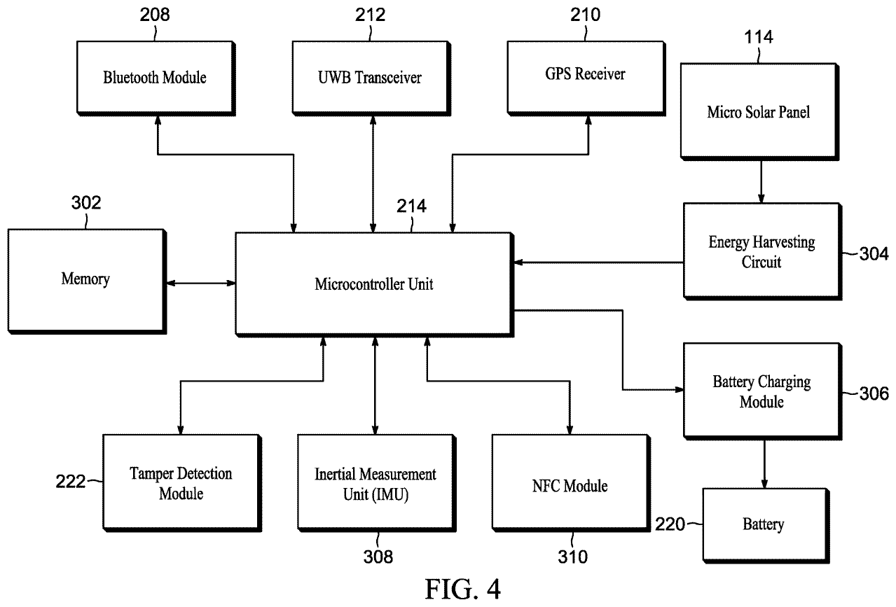

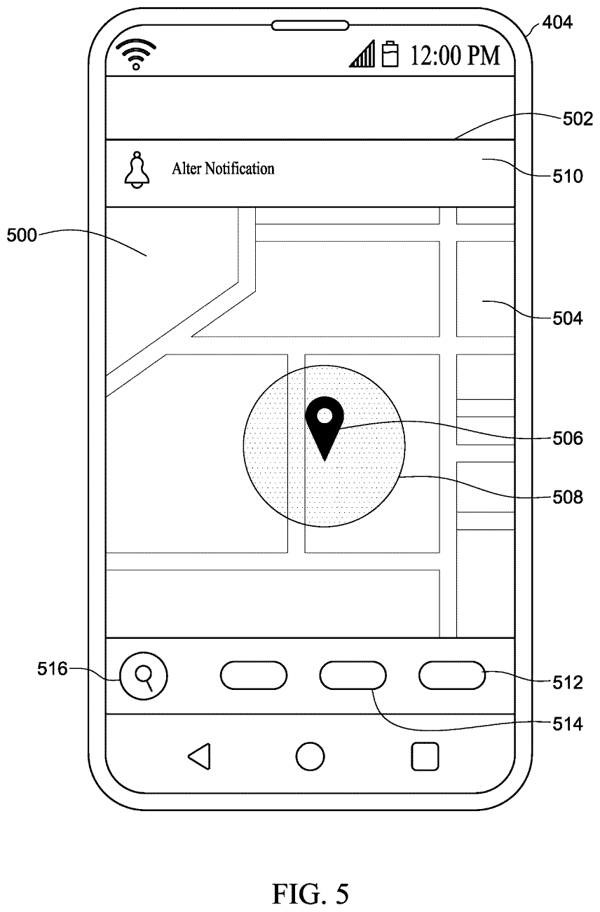

FIG. 5 illustrates a user interface screen of a mobile application in a user device for tracking the temple wire, in accordance with an embodiment of the present invention.

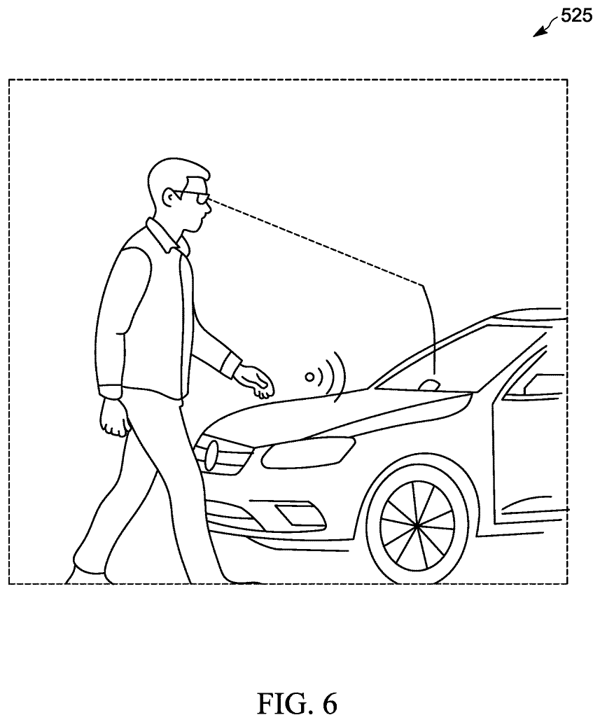

FIG. 6 illustrates the eyeglass with the UWB transceiver acting as a key to a secured access system, in accordance with an embodiment of the present invention.

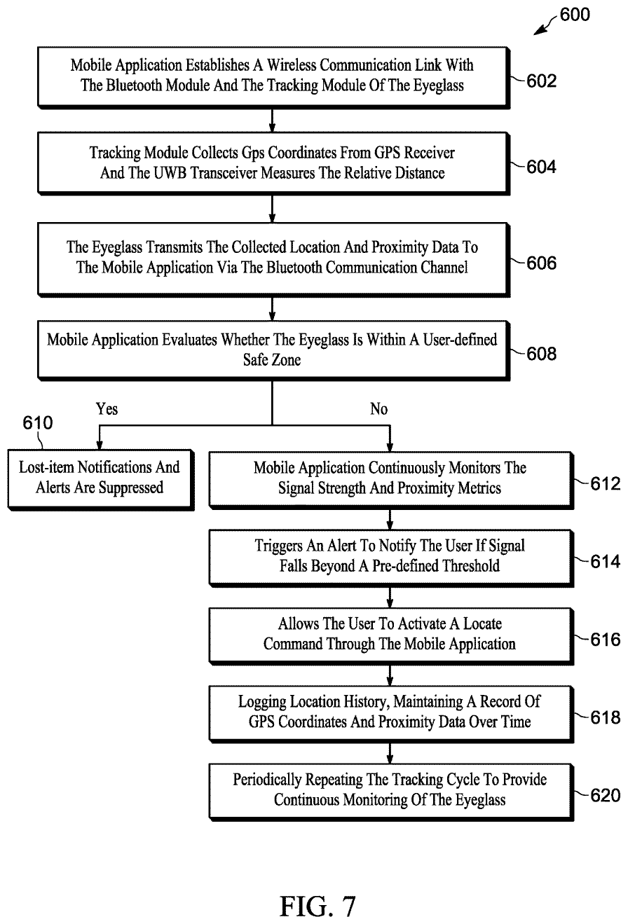

FIG. 7 is a flowchart showing a tracking and recovery method for the temple wire, in accordance with an embodiment of the present invention.

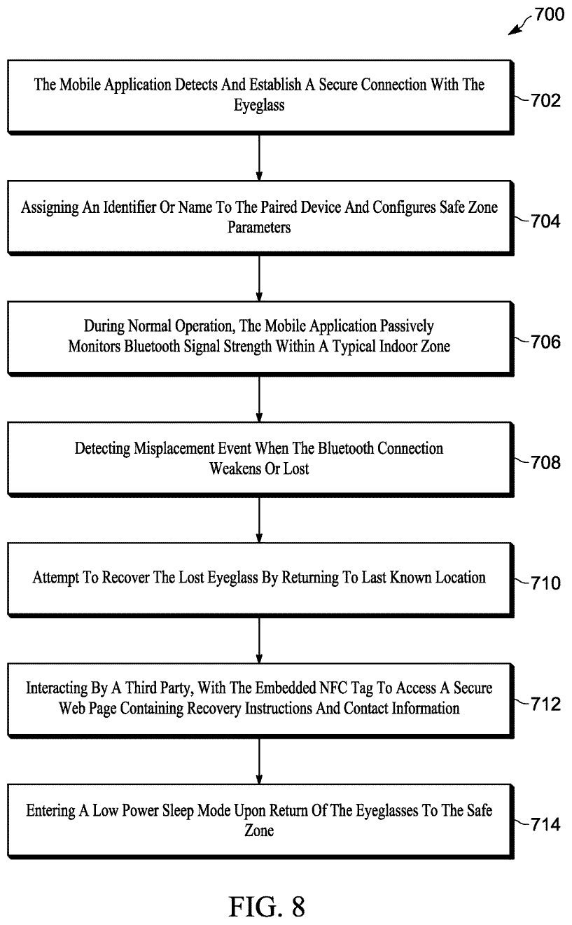

FIG. 8 is a flowchart showing a working example for locating a smart eyeglass using the mobile application, in accordance with an embodiment of the present invention.

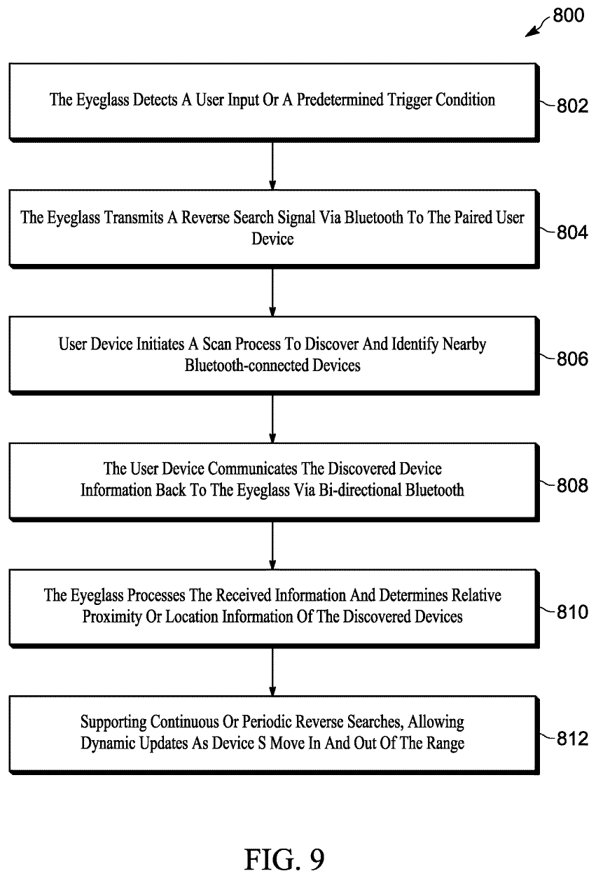

FIG. 9 is a flowchart showing a reverse searching process, in accordance with an embodiment of the present invention.

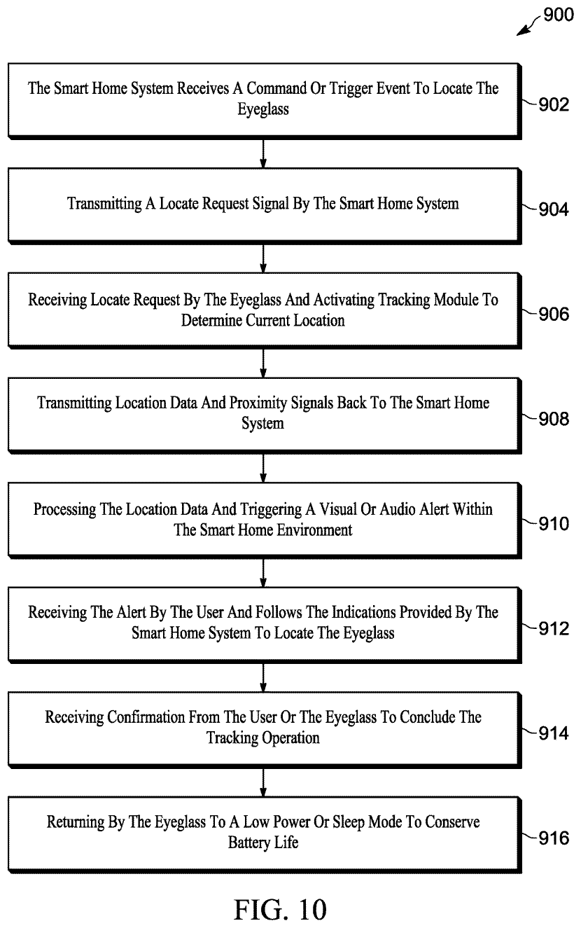

FIG. 10 is a flowchart showing a method for tracking the temple wire using a smart home system, in accordance with an embodiment of the present invention.

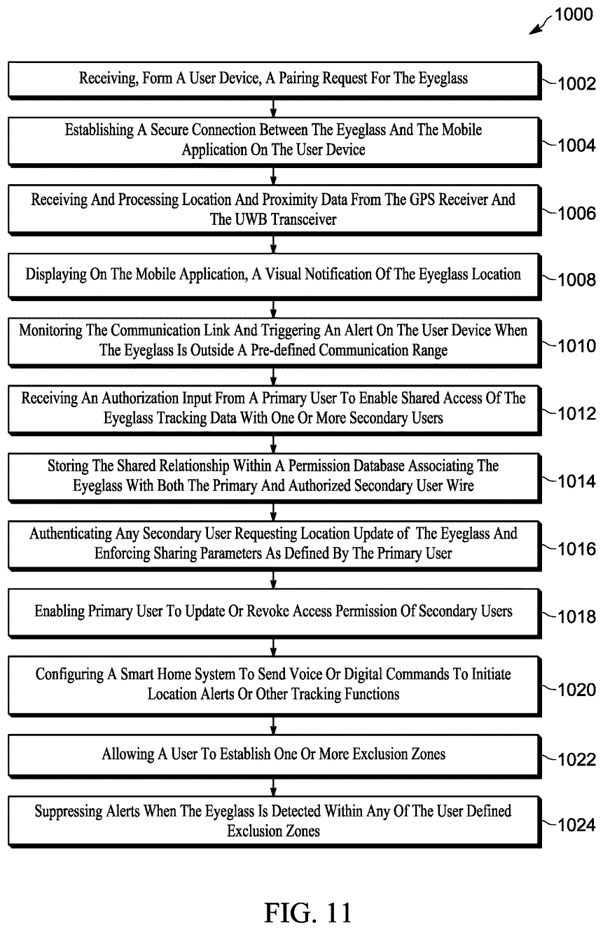

FIG. 11 is a flowchart illustrating a method for the shared location tracking and access management for the temple wire, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

Embodiments of the present invention provide a system for tracking an eyeglass. The system comprises a user device configured to execute a companion mobile application and an eyeglass having a communication module for establishing communication with the mobile application and a tracking module tracking the location of the eyeglass and proximity detection of the eyeglass with the user device. The eyeglass is provided with smart home integration functionalities. The communication module comprises at least one of Bluetooth, Bluetooth Low-Energy (BLE), Wi-Fi, UWB, NFC, IR, cellular modem, or a combination thereof. The tracking module comprises at least one of a GPS, a UWB transceiver, GNSS, a location-based Wi-Fi, or a combination thereof.

The user device is selected from but is not limited to a smartphone, smartwatch, a tablet, or other smart computing platform with wireless communication capabilities including Bluetooth, Wi-Fi, UWB, GPS, and NFC. The user device is configured to pair with, monitor, and control the eyeglasses and optionally connect to a cloud server to provide secure registration, location history, remote configuration, and anti-theft measures.

The core of the trackable eyeglass is a printed circuit board assembly (PCBA) having a low-power microcontroller unit (MCU)/processor, which acts as the central processing hub. The MCU is typically an ARM Cortex-M-based System on a chip, featuring integrated cryptographic hardware for secure key management, encrypted communication, and firmware authentication. The processor performs operations such as signal broadcasting, encrypted communication, sensor data handling, battery management, and user interaction (e.g., via a button or control switch), via a structured firmware architecture that utilizes I2C, SPI, UART, and GPIO interfaces.

The Printed Circuit board assembly comprises a communication module, such as a Bluetooth module, or a BLE module. The communication module is configured to interface with the mobile application on the user device and/or a smart home system. The communication module supports both classic Bluetooth and Bluetooth Low Energy (BLE) modes.

The Printed circuit Board assembly also includes a tracking module that includes at least one of a GPS receiver, GNSS, or other location tracking modules, configured to determine global coordinates when satellite signals are available. The tracking module may further comprise an Ultra-Wide Broadband (UWB) module configured to calculate the relative distance to nearby UWB-compatible devices with high accuracy. The UWB module may employ a Scrambled Time Sequence (STS) protocol for enhanced anti-spoofing protection.

The tracking module is operable to transmit both absolute (GPS-based) and relative (UWB-based) location data to a location processing application (the mobile application) running on a user device, such as a smartphone or other device. The location-processing mobile application is configured to display a visual notification of the last known or current location without necessarily generating a navigation route. This helps in conserving energy and avoids dependence on real-time mapping APIs. The location processing mobile application triggers an alert when the eyeglass moves out of a predefined proximity zone or loses connection with the paired device. The location processing application allows a user to disable lost-item notification when the eyeglasses with the eyeglass are within a user-defined safe zone (e.g. home or office). The tracking module enters into a low-power sleep mode when in proximity to a trusted Wi-Fi or BLE beacon to conserve energy.

The trackable eyeglass further comprises a memory to store ownership metadata, such as name, contact info, QR code, etc. locally. The ownership metadata may also be registered with a secure online database, allowing finders to return lost eyeglasses to the rightful owner.

In an embodiment, the trackable eyeglass is further operable to interface with a smart home system, such as Amazon, Alexa, Google Home, or Apple Homekit. The smart home system is configured to accept voice or app-based commands (e.g. “Alexa, find my glasses”) to trigger an audible alert or haptic feedback from the eyeglass for location identification.

In some embodiments, the Printed Circuit Board Assembly (PCBA) is further integrated with an Inertial Measurement Unit (IMU) for dead reckoning capabilities in GPS-derived environments, such as indoors or in tunnels.

The BLE (Bluetooth Low Energy) is configured to act as the primary communication module. The BLE transmits a unique, encrypted identifier using BLE advertisements. These identifiers can be received by the user device (a smartphone) or a third party participating in Bluetooth tracking networks, such as Apple's Find My or Google's Find My Device services. Upon reception, the receiving device uploads the detected beacon and its geolocation to a secure cloud server. The owner of the lost eyeglass can access the updated location via a native OS tracking interface or a dedicated cross-platform app. The system supports real-time or asynchronous tracking, depending on the connectivity and network availability.

To supplement BLE tracking and enhance positional accuracy, the eyeglass further includes an Ultra-Wideband (UWB) transceiver. The UWB transceiver facilitates high-precision ranging by calculating the time of flight and angle of arrival of RF pulses exchanged between the UWB transceiver and a UWB-capable smartphone or base station. Unlike BLE, which provides proximity estimates based on signal strength (RSSI), UWB provides centimeter-level spatial awareness, making it especially useful in cluttered, GPS-denied, or indoor environments. The mobile application on the user device may render UWB data in the form of compass-like indicators, directional arrows, or augmented reality (AR) overlays that guide the user to the lost object.

In an embodiment of the present invention, the UWB transceiver is an IEEE 802.15.4z-compliant UWB transceiver supporting time-of-flight (ToF) and angle-of-arrival (AoA) measurements. The system performs tri-lateration or multi-lateration using ranging data between the user device and the eyeglass, with updates occurring every few milli-seconds to produce real-time feedback. The UWB signal pulses are extremely short (on the order of nanoseconds) and spread across a wide spectrum (3.1 to 10.6 GHz), making them resilient to multipath interference and suitable for dense environments.

A Kalman filter or extended Kalman filter (EKF) may be implemented within the companion mobile application on the user device to fuse sensor data from the smartphone's inertial measurement unit (IMU) with UWB-ranging measurements, producing smooth, high-resolution positioning. In AR-enabled tracking modes, the application overlays a 3D directional arrow or object trail within a real-world camera view to guide users toward the trackable device. Azimuth and elevation angles are calculated from the phase difference of arrival (PDoA) or antenna array interpolation, enabling vertical differentiation in multi-storey structures.

In an embodiment, the trackable eyeglass further comprises a Near Field Communication (NFC) module to allow secure short-range interactions. The NFC (Near-Field Communication) module is embedded in the PCBA and supports contactless pairing, authentication, or data exchange with other NFC-compatible devices. For instance, when the device is placed in “Lost Mode,” its NFC tag becomes readable by any smartphone with NFC support. A finder who taps their phone to the item can view a customized message stored on a secure server, such as contact details, instructions for return, or a request for assistance. This implementation is privacy-conscious and allows recovery of lost property without disclosing the owner's identity unless explicitly permitted.

A tamper detection sensor is also provided in the eyeglass, which is a mechanical (spring-loaded contact), electrical (interrupt switch), or magnetic (Hall effect sensor), configured to generate a user alert if the housing is forcibly removed, opened, or otherwise compromised.

The trackable eyeglass further includes a cellular modem, the cellular modem offers long-range communication in off-grid or infrastructure-less environments.

The communication module in the eyeglass pairs with the user device via a user interface. The pairing process allows the trackable eyeglass to integrate seamlessly with the Bluetooth tracking network of the user device, enabling a range of functionality. Using a combination of Bluetooth and GPS technologies present in the eyeglass and the user device, the eyeglass can be tracked globally within Bluetooth range and beyond. The eyeglass reports its location to the user device, which is then displayed on the user interface. The user interface can display the location of the eyeglass on a map, which can be viewed in 2D, 3D, and satellite views, showing the last or updated location of the trackable device.

In an embodiment of the present invention, the companion mobile application configured to track the smart eyeglass serves as the primary user interface for interaction, location monitoring, and device management. Upon installation on a user device, such as a smartphone, tablet, or smartwatch, the mobile application enables secure pairing with the eyeglass using Bluetooth Low Energy (BLE) and optionally near-field communication (NFC). Once paired, the mobile application continuously or periodically receives data from the embedded tracking module, which includes the GPS receiver and the Ultra-Wide Band (UWB) transceiver. The mobile application processes this data to determine the current or last known location of the eyeglasses and displays this information via a graphical user interface (GUI). The GUI includes a traditional map view or an augmented reality (AR) view that overlays directional cues onto the live camera feed, helping the user physically navigate toward the eyeglasses.

The companion mobile application on the user's device or smartphone enables a user to view the real-time or last known location of the eyeglass on a dynamic map with satellite overlays. The UWB-enabled trackable device shows augmented directional arrows for close-range intervals. The user is able to define digital perimeters for the eyeglasses in the companion mobile application. The mobile application notifies the user when the eyeglass enters or exists the perimeter or boundary (geo-fence). The companion mobile application is configured to create and prioritize multiple nested or overlapping geo-fences. When the eyeglass is lost, it broadcasts BLE advertisements more frequently and enables auditory or vibration feedback. The companion mobile app generates a sharable lost device link or QR code and optionally joins third-party crowdsourced networks (e.g. Apple Find My Device, Google Find My Device) to expand recovery reach. Any attempt to reset or de-pair the lost device by unauthorized users triggers audible alarms and lockout timers in the mobile application. The mobile application continuously monitors RSSI and motion states. When the eyeglass is detected moving away from the user's phone beyond a configurable distance threshold, an alert is triggered. In the case of smartwatches, a minimalist version of the companion application can be used that allows features such as triggering alerts, viewing the last known location, receiving separate notifications, etc.

The companion mobile application features several intelligent modules, including a location processing engine that analyzes GPS coordinates, BLE signal strength, and UWB distance measurements to calculate proximity and movement. The mobile application also includes an alert module that notifies the user if the eyeglasses move outside of a user-defined safe zone, lose connectivity, or are subject to tampering. These alerts are delivered through push notifications, vibration, sound, or visual cues on the user's device. The mobile application further supports integration with smart home systems, enabling users to issue voice commands (e.g., “Hey Alexa, where are my glasses?”) that trigger a location response or an audible beacon from the temple wire.

In an embodiment of the present invention, the UWB transceiver in the eyeglass is used as a key for secure access systems. The UWB transceiver communicates with an external access system and is operable to authenticate and unlock a secured entry point, such as a vehicle, residence, or garage door, upon detection of proximity between the UWB transceiver and a corresponding UWB receiver integrated into the access system. The unlocking action is triggered based on predefined signal strength thresholds, spatial orientation, or motion patterns as determined by one or more onboard sensors, such as accelerometers, gyroscopes, etc. The UWB transceiver detects and measures distance to a paired UWB receiver using time-of-flight and broadcasts a secure device ID and initiates an encrypted handshake with the access system. The system utilizes an onboard accelerometer or gyroscope to confirm approach movement before unlocking and send an unlock command when both proximity and motion conditions are met.

The user interface includes a dashboard for managing multiple eyeglasses and displaying battery status, firmware versions, and signal strength. Users can configure safe zones, set power-saving modes, and initiate over-the-air firmware updates directly from the app. To preserve privacy and security, all communications between the eyeglass and the mobile application are encrypted using protocols such as AES or secure BLE pairing. Ownership metadata can be stored securely and used to facilitate recovery if the glasses are lost; for example, a finder could initiate a limited return interface without accessing personal data. Additionally, if the embedded tamper sensor detects unauthorized access to the circuitry of eyeglasses, the application generates an immediate alert and logs the incident with a timestamp and location.

The mobile application is configured to register the eyeglasses via BLE/NFC or QR code scanning. Upon registration, the mobile application stores the unique device identifier (UDID) of the eyeglass in a secure local or cloud-based database. The mobile application supports biometric authentication or PIN entry for accessing the mobile application. The mobile application periodically queries the eyeglass to update its location status, using GPS coordinates if satellite signals are available, relative UWB measurements when the eyeglass is within short range and Bluetooth signal strength for proximity detection. A map interface displays the last known location with a timestamp or current relative location using an AR directional overlay.

In an embodiment of the present invention, a user is able to define geo-fenced safe zones, such as home, office, car, etc. for the eyeglasses. When the eyeglass moves outside a predefined radius, the mobile application triggers an audio/visual alert, sends a push notification, or triggers haptic feedback via a smartwatch. The mobile application in some embodiment is configured to activate Find My Integration or initiate a remote audible ping on the eyeglass frame.

In an embodiment of the present invention, the mobile application enables linking the eyeglass to a smart home system, such as Amazon Alexa, Google Home, Apple Homekit, Google Find My Device, Apple Find My Device, etc. The integration with the smart home system allows a user to issue voice commands, such as “Hey Google, where are my glasses?”, “Alexa, locate temple wire”. The command is relayed through the mobile application to trigger audio or haptic feedback on the glasses.

The mobile application is configured to support multiple registered eyeglasses. For example, the mobile application is able to register multiple eyeglasses. The cross-platform supports ensure location data is synchronized via cloud services across smartphones, tablets, and desktop dashboards.

In an embodiment of the present invention, the mobile application provides a feature “Find other Devices”, in which the mobile application uses the Bluetooth module of the eyeglass to scan for nearby tagged items, such as a keychain, wallet, etc., and vice versa. The eyeglass utilizes Bluetooth GATT protocol to detect the presence of a secondary Bluetooth enable device within a communication range and transmits a command to trigger a predefined physical response, such as emitting an audible alert, vibrating or flashing a light on the secondary device. The interaction occurs locally without requiring location services or centralized network infrastructure. The eyeglass is configured to provide direct device-to-device communications to perform the triggering action on the secondary device without the need for a centralized mobile device. The peer-to-peer detection is independent of whether the devices originate from the same or different manufacturers, operate on distinct native networks, or are affiliated with different organizational domains. In some embodiments, the eyeglass communicates with the secondary device using the mobile application on the user's device.

When the mobile application detects low activity or safe zone entry, it instructs the eyeglass to enter a low-power sleep mode. The location polling frequency is dynamically adjusted based on the battery level, movement patterns, or time of day. In case the eyeglasses are broken, or tampered with, the embedded sensor triggers an alert which is forwarded to the mobile application. The user receives a notification with a timestamp and the last known location of the event.

The mobile application also allows a user to input ownership metadata, such as name, contact information, or emergency instructions. If the eyeglasses are lost and found by another user or recovery agent, a return interface is presented via NFC tap or QR scan, revealing limited return contact options while protecting privacy. The mobile application is configured to provide over-the-air (OTA) updates to firmware modules in the temple wire.

In an embodiment of the present invention, the trackable eyeglass comprises a shared access management feature, which enables controlled and secure sharing of tracking data with one or more secondary users, in addition to the primary user. The primary user provides an authorization input in the mobile application designating permission to share the tracking data of eyeglasses with selected secondary users. Each secondary user is uniquely identified using account credentials, such as an email address, username, and secure token, authenticated through multi-factor verification. The authorization inputs can be provided through a companion mobile application, web dashboard, or voice command integrated with a smart assistant. The system creates and stores a sharing relationship within a permission database, linking the eyeglasses with both the primary and approved secondary users. When a secondary user attempts to request real-time or historical location data of the eyeglass, the system performs authentication procedures and enforces access control based on predefined parameters established by the primary user. The parameters may include time-based limitations, geographical restrictions, conditional rules, etc. The primary user retains full authority to update, modify, or revoke access permission granted to secondary users. On such action, the permission database is immediately and automatically updated to reflect the new access state, ensuring real-time enforcement of any changes without manual intervention.

The Graphical user interface (GUI) or the user interface of the mobile application includes a dashboard that provides an overview of connected devices and status, a map view that provides current or last known location with filtering options, a safe zone manager that is used to define, edit or remove geo-fenced areas, an alert center that keeps log of alerts, tamper events, and connection interruptions, a setting panel to configure voice assistant pairing, notification behavior, device sharing, and power modes, and help and support.

The mobile application triggers alerts based on pre-defined conditions, such as the eyeglass moving outside a user-defined safe zone, connection loss due to disturbance or obstructions, and tamper detection events reported by the embedded sensor. The alerts include push notifications, sound or vibration cues on the user device, and visual cues on connected wearables.

In an embodiment of the present invention, the smart eyeglass provides an anti-stalking feature designed to enhance user safety and prevent unauthorized or covert tracking attempts. The eyeglass periodically scans its surroundings for BLE or UWB beacons broadcasted by other trackable devices. If it detects a signal from a tracker that is not paired with or recognized by the user's profile or device ecosystem, the system identifies it as a potential unauthorized tracker. The system performs spatiotemporal correlation by logging the repeated or persistent presence of the unknown tracker across different locations over time. If the unknown signal consistently follows the user across multiple, unrelated geographical locations, it is flagged as a stalking threat. In order to minimize false positives, the eyeglass evaluates signal strength (RSSI), proximity distance, and dwell time. A warning is generated if the unknown tracker is detected within a close range for a longer period, or appears repeatedly in diverse unrelated locations. When suspected stalking is detected, the system triggers an alert notification to the user by providing haptic feedback, audio alert, or visual notification via the companion mobile application.

In an embodiment of the present invention, the method for tracking an eyeglass is provided. The method involves a multi-layered approach that leverages various wireless communication technologies, location-determining protocols, and user-interface mechanisms to ensure reliable, real-time tracking and proximity awareness. Upon initial setup, the user installs a proprietary mobile application on a user device, such as a smartphone, tablet, or smartwatch. The mobile application initiates a pairing process with the eyeglass through Bluetooth Low Energy (BLE) or Near Field Communication (NFC). During this process, the mobile application authenticates the eyeglass's unique identifier and once successfully paired, creates a secure, encrypted communication link using a protocol like AES or secure BLE pairing. Once paired, the tracking module of the eyeglass becomes active. When outdoors or in areas with strong satellite visibility, the GPS receiver calculates the absolute geographic coordinates (latitude and longitude) of the eyeglass. These coordinates are periodically transmitted to the mobile application, where a location processing engine interprets and visualizes the data.

In indoor or GPS-denied environments, such as inside a building, the UWB transceiver is activated to measure the Time of Flight (ToF) between the eyeglass and the user device (or another UWB anchor). This enables accurate calculation of relative distance within a few centimeters. The UWB signal is encrypted using a Scrambled Time Sequence (STS) to prevent spoofing or unauthorized location tracking. Simultaneously, BLE is used to monitor Received Signal Strength Indication (RSSI). The mobile application is able to determine coarse proximity (eg. Near, far, out of range) based on signal attenuation and provide additional proximity feedback when UWB or GPS is not available.

The mobile application receives data from the eyeglass and processes it to determine the current location (if the device is actively transmitting) or the last known location (if the device went offline or is out of range). The data is displayed on a map-based interface or via Augmented Reality using the device camera. The AR overlay guides the user toward the eyeglass with directional arrows, distal indicators, and real-time updates.

The mobile application allows the user to define one or more geo-fenced “safe zones”. When the eyeglass enters or exits a safe zone, the system disables notifications to conserve battery. The eyeglass enters a low-power sleep mode when within a safe zone or after a defined period of inactivity. The mobile application periodically “pings” the eyeglass to check for status updates without fully activating GPS or UWB, conserving battery life while maintaining situational awareness.

If the eyeglass moves beyond the zone's perimeter unexpectedly, an alert is triggered on the mobile application. If the eyeglass is out of range or tampered with, the mobile application triggers real-time alerts via push notification, sound, or haptic feedback; the eyeglass emits a beep or vibration to assist with physical location; if lost, a lost mode is activated, displaying contact or ownership metadata securely via NFC or BLE beacon to aid recovery by a finder.

The method includes compatibility with smart home systems (e.g. Amazon Alexa, Google Home). The user is able to issue voice commands such as “Where are my glasses?” which trigger the temple wire to emit a signal or update its location in the mobile app.

In an embodiment of the present invention, a temple wire is provided, which is configured to be affixed to a standard eyeglass frame. The temple wire is a long, slender rod, which serves as the structural support member for the temple arm. The temple wire is fabricated from a rigid or semi-flexible metallic or polymeric material, ensuring durability while maintaining lightweight characteristics. The communication module and the tracking module are embedded in the temple wire. When the temple wire is affixed to the eyeglass, it imparts a trackable feature to the eyeglass.

The temple wire comprises a compact, ruggedized electronic module enclosed within a housing that meets industry durability and ingress protection standards, such as IP67 or MIL-SD-810. The housing is made of a material such as polycarbonate, ABS, or another durable lightweight material. The housing contains the key electronic subsystems of the trackable device of the temple wire. The housing has a smooth, contoured exterior suitable for comfortable contact with the side of the head or temple region.

One end of the temple wire is designed to be tapered, which serves as a mounting interface or connector for insertion into or alignment with a corresponding hinge or slot in the eyeglass frame. The mounting interface or the connector can be a hinge joint for attachment to the eyeglass frame, a screw slot, a snap-fit, or a slide-in groove for physical coupling.

In an embodiment of the present invention, the temple wire is configured to be inserted directly in plastic glasses, shaped into glasses using a mold, or inserted as a module in plastic glasses to make the plastic glasses trackable.

In an embodiment, the trackable eyeglass comprises one or more antennas physically separated from the adjacent metallic frame elements using a polycarbonate dielectric barrier to minimize interference and maximize signal integrity.

The trackable device in the temple wire is powered by a power source. The power source can be a rechargeable battery, typically lithium-polymer or solid-state), governed by a smart battery management IC (BMIC). The subsystem supports multiple charging modalities, including wireless charging via the Qi standard, USB-C wired input, and optionally, solar energy harvesting via a photovoltaic panel integrated into the housing. A power management module regulates voltage supply across the device's communication, processing, and sensing subsystems. In an embodiment, a micro solar panel is integrated into the outer shell of the housing. The micro solar panel is coupled with an energy harvesting circuit to trickle-charge a rechargeable battery or supercapacitor.

In an embodiment, the present invention provides a smart eyeglass system comprising a first temple wire configured to attach to the left side of an eyeglass frame and a second temple wire configured to attach to the right side of the eyeglass frame. Each of the first temple wire and the second temple wire is embedded with a Bluetooth communication module, configured to pair with a distinct mobile operating system tracking network. For example, the first Bluetooth module is configured for Apple Find My Device, while the second Bluetooth module is configured for Google Find My Device. The dual network configuration increases redundancy and improves the likelihood of successfully locating the smart eyeglass system across various user ecosystems.

FIG. 1 is a block diagram illustrating the system-level architecture for tracking the eyeglass 101. The system architecture integrates the on-device tracking components with an external user device, tracking networks, and optional smart home ecosystems.

The eyeglass 101 contains embedded electronics, including the tracking module 402, the Bluetooth module 208, and the microcontroller unit (MCU) 214. The tracking module 402 comprises the GPS 210 and the UWB transceiver 212. The GPS interfaces with a constellation of global navigation satellites, such as GPS, GLONASS, Galileo, or BeiDou, to derive absolute geolocation data. It functions as a beacon-like locator, highlighting the device's spatial context. This data is periodically transmitted to the user device 404, such as a smartphone or tablet, via the Bluetooth module 208 using a secure BLE connection.

The UWB transceiver 212 operates as a high-accuracy ranging engine within the eyeglass 101, capable of exchanging ultra-wideband pulses with a compatible UWB chip embedded in the user device 404, enabling relative distance. Unlike conventional radio-based tracking methods, UWB enables extremely accurate, low-latency distance measurements, often within the range of a few centimeters, by calculating the time-of-flight of nanosecond-scale pulses. The measured proximity data enhances the ability of the system to locate the eyeglass 101 even in environments where GPS signals are degraded or unavailable. Through secure communication protocols, including Scrambled Time Sequence (STS) encryption, the UWB transceiver not only achieves high-resolution ranging but also ensures robust resistance to spoofing or unauthorized signal injection, reinforcing the integrity of the proximity data.

The user device 404 executes a mobile application 406, configured to receive, decode, and interpret location and proximity signals from the eyeglass 101. The mobile application 406 shows information on a display 418, showing real-time proximity indicators, a map-based view of the last known location, and interactive controls for initiating sound alerts or activating visual indicators on the eyeglasses.

The eyeglass 101 is also configured to interact with a cloud-based tracking service 410, which may include mobile operating system-based device location platforms, such as Apple® Find My™ or Google® Find My Device™. The Bluetooth module 208 can broadcast encrypted beacons detected by other devices in the ecosystem, which relay the approximate location of the eyeglass to the cloud service 408, enabling crowdsourced tracking.

In an embodiment, the eyeglass 101 is configured to interface with a smart home system 412, such as Amazon Alexa™, Google Home™, or Apple Homekit®. The Bluetooth module 208 or a Wi-Fi chip enables the eyeglass 101 to register with the home network. Upon voice command, the smart home system 412 triggers the mobile application 406 to activate an alert on the eyeglass 101, thereby assisting the user in locating the eyeglasses within the premises.

The system architecture can also include a secure database 416 that stores sets of metadata such as device ownership, device identifiers, user-defined safe zones, and historical location logs. The system is provided with geo-fencing functionalities, whereby virtual boundaries are defined around specific geographic areas (e.g., home, office, or gym), allowing the system to recognize when the eyeglass is within or outside these pre-configured zones. When the eyeglass is detected within a designated safe zone, the system can automatically suppress lost-item alerts or reduce tracking frequency. Conversely, if the eyeglass unexpectedly exits a geo-fenced area, automated alerts or location tracking can be escalated in response. The generated data can be used to enable the automatic disabling of lost-item notifications within safe zones or to facilitate the return of lost glasses by providing limited access to ownership contact information through the NFC module 310 or the cloud-based tracking service 410.

In operation, the architecture supports a bidirectional feedback loop. The user device 404 sends commands via the mobile application 406 to activate alert features on the eyeglass 101, while the temple wire 100 periodically transmits beacon signals or event-based alerts (e.g., tamper detection or motion events) to the user device 404 or cloud-based tracking service 410. These interactions are secured using cryptographic authentication and optional blockchain-based audit logs for tampering and location history verification.

Referring to FIG. 2, a perspective view of a temple wire configured for attachment to an eyeglass frame is illustrated. The temple wire 100 comprises an elongated housing 102 enclosing a plurality of embedded electronic modules and components. The housing 102 is configured to serve both as a structural support for the eyeglass and as a carrier for intelligent tracking and communication systems.

The temple wire 100 is configured to be affixed to a standard eyeglass frame. The temple wire 100 is a long, slender rod, which serves as the structural support member for the temple arm. The temple wire 100 is fabricated from a rigid or semi-flexible metallic or polymeric material, ensuring durability while maintaining lightweight characteristics.

The housing 102 may be constructed from a lightweight, impact-resistant polymer such as polycarbonate, ABS, or a reinforced composite material, and is shaped to conform ergonomically to the wearer's head while maintaining a form factor consistent with conventional eyeglass temple arms. The shape and dimensions of the housing may be adapted to match the contours of standard eyeglass temple arms and conform ergonomically to the wearer's head while maintaining a form factor consistent with conventional eyeglass temple arms.

The temple wire 100 comprises a compact, ruggedized electronic module enclosed within the housing 102 that meets industry durability and ingress protection standards, such as IP67 or MIL-SD-810. The housing 102 contains the key electronic subsystems of the trackable device of the temple wire 100. The housing has a smooth, contoured exterior suitable for comfortable contact with the side of the head or temple region.

The temple wire 100 is mechanically integrated with a hinge mechanism 104, which facilitates connection to a wide range of third-party eyeglass frames. The hinge mechanism 104 comprises but is not limited to a snap-fit connector, screw-fastening unit, or solderable metallic interface, allowing versatile retrofitting and replacement.

In an embodiment of the present invention, the temple wire is configured to be inserted directly in plastic glasses, shaped into glasses using a mold, or inserted as a module in plastic glasses to make the plastic glasses trackable.

Embedded within the housing 102 is a Bluetooth communication module, a tracking module comprising a GPS receiver, ultra-wideband (UWB) transceiver. The tracking module is configured to transmit location and proximity signals to a mobile application stored and executed on a user device. The mobile application is operable to display the last known or real-time location of the Temple Wire 100 and issue a user alert if the Temple Wire 100 moves beyond a predefined Bluetooth or UWB range. The system may operate without providing turn-by-turn navigation, relying instead on proximity indicators and location flags.

In an embodiment, the temple wire 100 further comprises a micro solar panel 114 disposed on an upper or outward-facing surface of the housing 102.

Referring to FIG. 3A and FIG. 3B, the temple wire 100 includes an upper housing segment 202 and a lower housing segment 204, together forming the housing 102 that encloses and protects the internal electronic and mechanical assemblies. The upper housing segment 202 and the lower housing segment 204 are constructed from a lightweight and durable polymeric material, such as polycarbonate or ABS, and can incorporate metallic or carbon fiber shielding layers to suppress electromagnetic interference (EMI).

The housing 102 accommodates a printed circuit board (PCB) 206, which serves as the main substrate for the electronic modules. The PCB 206 is mounted with a Bluetooth module 208, a GPS 210, a UWB transceiver 212, and a microcontroller unit (MCU) 214, interconnected via conductive traces or a multi-layer interconnects structure.

The Bluetooth module 208, GPS 210, and the UWB transceiver 212 are being coupled to one or more antennas 216 that are positioned at the distal ends of the housing 102 in a spatially optimized manner to maximize signal exposure and minimize electromagnetic cross-talk. In FIG. 3B, the antenna 216 is shown embedded on the back surface of the top cover 202 of the housing. The placement of one or more antenna 216 can be in other configuration as well. A dielectric barrier 218, constructed of polycarbonate or similar non-conductive material, is positioned to separate one or more antennas 216 from any adjacent metallic elements, including portions of the temple wire 100, thereby preserving signal integrity and transmission efficiency.

A battery 220, such as a lithium-polymer cell, is included to supply power to the embedded electronics. The battery 220 is electrically coupled to the micro solar panel 114 via an energy harvesting circuit, which regulates and conditions incoming solar energy. The energy harvesting circuit comprises a charge controller and step-down converter designed to optimize power capture under variable lighting conditions.

A tamper detection module 222, which may include a magnetic sensor, flex sensor, or micro-switch, is disposed of adjacent to a seam or screw fixture within the housing 102 that is most susceptible to tampering or unauthorized access. The tamper detection module 222 is configured to detect, such as unauthorized disassembly, physical manipulation, minute deflections, displacements, or changes in magnetic flux and transmit an alert through the Bluetooth module 208 upon detection.

The hinge mechanism 104 is shown disengaged in the exploded configuration. The hinge mechanism 104 includes a rotational pin and a snap-fit or screw-mount interface that attaches to a reinforced hinge boss on the lower housing segment 204. The hinge mechanism 104 allows the temple wire 100 to pivot relative to the eyeglass frame, enabling foldability and ergonomic fitment across third-party eyeglass models without compromising stability or comfort. Referring to FIG. 3C, the attachment of the temple wire 100 on the eyeglass frame 108 is illustrated. The hinge 104 of the temple wire 100 attached to the eyeglass frame 108.

FIG. 4 is a block diagram illustrating the components of the embedded electronics within the temple wire 100 of the smart eyeglass frame. The components are mounted on the printed circuit board 206 housed within the temple wire 100.

At the core of the system is a microcontroller unit (MCU) 214, which orchestrates operations across the embedded modules and peripherals. The MCU 214 is operatively coupled to multiple components via a shared bus or signal lines and executes firmware instructions stored in a non-volatile memory 302.

The Bluetooth module 208 serves as the wireless communication hub of the system, engineered to establish a secure, low-latency connection with a mobile application operating on a user device (e.g., smartphone or tablet). The Bluetooth module 208 supports Bluetooth Low Energy (BLE) protocol and is capable of both transmitting and receiving encrypted data packets related to proximity, tamper alerts, ownership verification, and command instructions. The Bluetooth module 208 may support multi-point connectivity, enabling simultaneous pairing with multiple user devices or smart home hubs, and facilitating the dynamic role switching between central and peripheral communication modes.

The GPS 210 is communicatively connected to the MCU 214 and receives location data from a global navigation satellite system (GNSS), including but not limited to GPS, GLONASS, Galileo, and BeiDou. The UWB transceiver 212 is configured to enable precision ranging by exchanging ultra-wideband pulses with external UWB-compatible devices (e.g., a smartphone or locator hub) to enhance location accuracy, especially in urban environments or semi-obstructed areas where satellite visibility is partially degraded. The UWB transceiver 212 enables centimeter-level precision ranging by exchanging high-frequency, low-power UWB pulses with compatible external devices such as smartphones or dedicated locator hubs. The UWB transceiver 212 supports secure ranging via Scrambled Time Sequence (STS) protocols for a security-enhanced mechanism designed to randomize timestamps, thereby mitigating risks of signal spoofing or unauthorized tracking.

The system further includes an energy harvesting circuit 304, electrically coupled to a micro solar panel 114. The micro solar panel 114 is engineered to capture ambient light across a broad spectral range, including indoor lighting and indirect sunlight, and convert it into electrical energy. The output of the energy harvesting circuit 304 is routed to a battery charging module 306, which regulates the safe and efficient delivery of energy flow to the battery 220 and serves as the primary power source for the temple wire electronics.

To enhance environmental sensing and operational robustness, an inertial measurement unit (IMU) 308 is provided in the system. The IMU 308 comprises a multi-axis accelerometer and gyroscope, capable of detecting orientation, motion, and displacement, which is useful for dead reckoning in GPS-denied areas such as indoors or underground locations. The IMU data is processed by the MCU 214 which applies advanced motion filtering, pattern recognition, and anomaly detection algorithms to interpret the user's activity profile and generate alerts for unauthorized motion or drops.

The tamper detection module 222 is also interfaced with the MCU 214. The tamper detection module 222 consists of a flex sensor, a magnetic reed switch, or a micro switch positioned at junction points in the housing 102 to detect unauthorized opening or tampering attempts. This generates warnings for unauthorized movement, device drops, or impact events indicative of theft, tampering, or accidental damage. When integrated with other subsystems such as GPS, Bluetooth, and UWB, the IMU significantly enhances the system's contextual awareness and operational autonomy, enabling intelligent behavioral inference and robust location continuity across diverse and dynamic environments.

An NFC module 310 is integrated into the PCB 206 to enable short-range wireless communication for identification, access control, or contactless pairing with mobile devices or smart terminals. The NFC module 310 is configured to store device metadata, such as owner ID or return instructions, which can be accessed by an NFC-enabled reader even in the event of the battery 220 depletion. This ensures the Temple Wire 100 remains identifiable and recoverable, with high security and traceability in case of loss or theft.

In an embodiment, the PCB 206 includes a temperature sensor positioned to monitor the internal thermal environment of the temple wire 100. During operating conditions the system automatically triggers an alert if the internal temperature exceeds safe thresholds, protecting the circuitry and battery from thermal damage.

All communication, control, and data exchange between modules are managed under secure protocols, optionally including encryption modules embedded in the firmware of the MCU 214. The system architecture ensures real-time responsiveness, robust location tracking, and seamless integration with smart home networks or mobile operating system tracking ecosystems (e.g., Apple® Find My™, Google® Find My Device™).

FIG. 5 depicts a user interface of a mobile application executed on the user device 404, configured to track and locate the temple wire 100 of the smart eyeglass system. The mobile application also referred to as a location processing application, provides the user with real-time visual and interactive controls to facilitate the detection, monitoring, and recovery of the Temple Wire 100.

The user interface 500 includes a main display area 502 which presents a map view 504 showing the last known or current geographic location of the temple wire 100. The location data is obtained from the GPS 210 embedded within the tracking module 402 of the temple wire 100. The map view 504 is configured to allow standard navigation gestures including zooming and panning, and supports multiple map modes, such as satellite imagery, terrain view, or street map view, to enhance user comprehension and navigation.

An indicator icon 506 is displayed on the map view 504 to represent the precise position of the temple wire 100. When the temple wire 100 is within proximity, as determined by signals from the Ultra-Wideband (UWB) transceiver 212, the user interface 500 further presents a proximity meter 508. The proximity meter 508 dynamically reflects the relative distance between the temple wire 100 and the user device 404 by interpreting the time-of-flight or signal strength metrics reported by the UWB transceiver 212, thus aiding the user in approximating the physical location of the eyeglass.

The user interface 500 also displays alert status indicators 510 that notify the user of important device conditions. These include low battery warnings for the Temple Wire 100, triggered when the onboard power source falls below a predetermined threshold; tamper alerts generated by the tamper detection module 222 embedded in the housing 102 of the Temple Wire 100, which notify the user if unauthorized removal or manipulation is detected; and out-of-range alerts that activate when the temple wire 100 moves beyond a configurable Bluetooth or UWB communication range.

A control panel within the user interface 500 presents interactive buttons for various functions. The “Locate” button 512, when actuated, causes the temple wire 100 to emit an audible beep or activate one or more visible indicators such as LEDs, thereby assisting the user in quickly finding the physical eyeglass. The “Safe Zone” toggle 514 enables the user to define geo-fenced areas within which lost-item notifications are suppressed, thereby preventing false alarms when the user is in trusted locations. Additionally, the interface includes a “Reverse Search” button 516, which initiates a reverse locating process wherein the temple wire 100 actively attempts to locate the paired user device.

In an embodiment, the user interface 500 is further configured to show other statuses, such as a battery status icon prominently displaying the remaining charge of the temple wire energy source and a device information panel that provides metadata such as the unique device identifier, registered owner information, firmware version, and the timestamp of the last successful synchronization event.

Security features are integrated into the mobile application to restrict access to tracking data and control commands. Authentication mechanisms such as biometric login (e.g., fingerprint or facial recognition) or password-based access ensure that only authorized users may access sensitive tracking functionalities. Additionally, the mobile application also supports gesture-based authentication and control, allowing users to perform predefined gestures such as drawing specific patterns on the screen or executing swipe sequences to unlock access to certain tracking features or initiate specific commands (e.g., triggering a location alert or toggling safe zone modes).

All communications between the mobile application 406 and the Temple Wire 100 are protected by end-to-end encryption, employing industry-standard cryptographic protocols to prevent unauthorized interception, spoofing, or tampering with location data.

In addition to the on-demand tracking functionalities, the mobile application 406 supports push notifications to proactively alert the user regarding critical events such as the Temple wire 100 moving out of range, tampering detection, or low battery conditions. These notifications ensure timely user awareness and facilitate prompt recovery actions.

Through the combination of real-time geolocation, proximity sensing, alert management, and secure communication, the user interface 500 of the mobile application 406 provides a robust, user-friendly, and comprehensive platform for the effective tracking and recovery of the temple wire 100 of the smart eyeglass, thereby minimizing loss and enhancing user convenience.

FIG. 6 illustrates an exemplary environment 525 showing the use of an eyeglass frame to communicate with an external access system. The eyeglass is equipped with an ultra-wideband (UWB) transceiver for secure and intelligent access control. In FIG. 6, a user wearing the eyewear approaches a vehicle equipped with a UWB antenna. As the user nears the vehicle, the UWB transceiver in the eyewear initiates communication with the vehicle's UWB receiver to determine proximity using time-of-flight measurements.

Upon detecting the user's approach, as confirmed through spatial orientation and motion pattern analysis via onboard sensors such as accelerometers and/or gyroscopes, the system initiates a secure authentication process. The eyewear transmits a secure device identifier and performs an encrypted handshake with the vehicle's access system. If proximity thresholds and directional movement conditions are satisfied, the eyewear device transmits an unlock command to the vehicle.

FIG. 7 illustrates a flowchart 600 representing a tracking and recovery method for the smart eyeglass. The method is implemented by the mobile application 406 executing on the user device 404 in conjunction with the embedded electronics within the eyeglass.

The process begins at step 602, wherein the mobile application 406 establishes a wireless communication link with the Bluetooth module 208 and the tracking module 402 of the eyeglass. The Bluetooth connection enables bi-directional data exchange between the user device 404 and the eyeglass, facilitating the transmission of location, proximity, and status information.

In step 604, the tracking module 402 collects GPS coordinates from the GPS 210 embedded within the eyeglass, providing global positioning data indicative of the eyeglass's geographic location. Concurrently, the UWB transceiver 212 measures the relative distance between the eyeglass and the user device 404 by calculating time-of-flight or signal strength parameters.

At step 606, the eyeglass transmits the collected location and proximity data to the mobile application 406 via the Bluetooth communication channel. The mobile application 406 receives and processes this data to update the user interface 500, presenting the latest position and distance information to the user.

Step 608 involves the mobile application 406 evaluating whether the eyeglass is within a user-defined safe zone. If the eyeglass is located inside the safe zone, the method proceeds to step 610 where lost-item notifications and alerts are suppressed to prevent unnecessary user disturbance.

If the eyeglass is outside the safe zone, the method advances to step 612, wherein the mobile application 406 continuously monitors the signal strength and proximity metrics. If the signal falls below a predefined threshold, indicating the eyeglass is moving out of range, an alert is triggered at step 614 to notify the user of the potential loss or separation.

Step 616 allows the user to activate a locate command through the mobile application interface, which causes the eyeglass to emit an audible beep or light signal via onboard indicators, facilitating the physical recovery of the eyeglass.

The flowchart further includes step 618 where the mobile application 406 logs the location history of the eyeglass, maintaining a record of GPS coordinates and proximity data over time to assist in retrospective location analysis.

Finally, the method concludes at step 620 with the mobile application 406 periodically repeating the tracking cycle to provide continuous monitoring and up-to-date information on the eyeglass status and location.

This tracking and recovery method combines GPS-based geolocation with UWB proximity sensing and user-configured safe zones to deliver an efficient, reliable, and user-friendly solution for locating and securing the eyeglasses.

FIG. 8 illustrates a flowchart 700 representing a working example of a method for locating a smart eyeglass system embedding a Bluetooth module 208, a GPS 210, and an Ultra-Wideband (UWB) transceiver 212. The method is executed through a mobile application 406 installed on a user device 404 such as a smartphone.

Initially, at step 702, the user opens the mobile application 406 on the user device 404 and brings the device in close proximity to the eyeglass. The mobile application 406 utilizes the Bluetooth module 208 or Near Field Communication (NFC) to detect and establish a secure connection with the eyeglass. The user assigns an identifier or name (e.g., “Work Glasses”) to the paired device and optionally configures safe zone parameters, such as the user's home Wi-Fi area, at step 704.

In step 706, during normal operation, the mobile application 406 passively monitors the BLE signal strength within a typical indoor range of approximately 5 to 10 meters. The eyeglass periodically transmits status updates including battery level, device health, and GPS coordinates (if available) to the mobile application 406. The user interface 500 provides a dashboard view showing real-time device status, location within the safe zone, battery percentage, and signal strength, thereby informing the user of the device's operational condition.

At step 708, a misplacement event is detected when the BLE connection weakens or is lost, for example when the user leaves the eyeglasses behind at a public location such as a café. The application 406 triggers a “Left Behind” alert notification if the lost item is outside the predefined safe zone within a short interval (e.g., 30 seconds). The mobile application 406 logs the last known GPS location on a map interface and records proximity data from the UWB transceiver 212 (if available). This assists in indicating the last detected range (e.g., within 2 meters) before disconnection.

Step 710 involves the user's attempt to recover the eyeglasses by returning to the last known location. Upon re-establishing BLE connectivity, the mobile application 406 automatically switches to UWB-based proximity mode. The user interface dynamically updates to show real-time relative distance measurements (e.g., 2.4 m decreasing to 0.5 m), assisting the user in physically homing in on the eyeglasses.

Further, the mobile application 406 may provide augmented reality guidance by overlaying directional arrows on the camera view of the user device 404 to visually point toward the eyeglass. An interactive “Make Sound” control triggers an audible alert generated by the eyeglass, facilitating the location of the eyeglasses through audio cues.

In step 712, if a third party discovers the lost eyeglasses, they may interact with the embedded NFC tag to access a secure web page containing recovery instructions and contact information. The owner receives a notification containing the finder's message and coordinates, enabling secure and convenient recovery of the eyeglasses.

Step 714 addresses power management wherein, upon return of the eyeglasses to the safe zone, the system enters a low-power sleep mode. BLE connectivity is maintained at a reduced interval, while GPS and UWB modules are deactivated to conserve battery life. The system dynamically reactivates GPS and logs location data when the eyeglass moves outside the safe zone without the paired user device 404.

This working example comprehensively demonstrates the practical usage cycle of the smart eyeglass system including initial pairing and configuration, continuous monitoring via BLE, GPS location logging, precise indoor ranging using UWB, interactive visual and audio recovery aids, tamper-aware NFC-enabled recovery, and intelligent power management to optimize battery performance.

FIG. 9 illustrates a flow diagram 800 representing the reverse searching process performed by the eyeglass and the paired user device (e.g., smartphone). This process enables the eyeglass to initiate and coordinate location queries to discover other Bluetooth-connected devices within the surrounding environment, leveraging bi-directional data exchange.

At step 802, the eyeglass detects a user input or a predetermined trigger condition that initiates the reverse search operation, a high-utility feature designed to locate the paired user device or activate a retrieval sequence. This trigger may take the form of a voice command, such as a spoken keyword processed via a smart home assistant or on-device microphone, or a digital request transmitted from a companion mobile application.

At step 804, the eyeglass transmits a reverse search signal via its Bluetooth module 208 to the paired user device. This signal prompts the user device to perform an active scan for other Bluetooth-enabled devices within its communication range.

At step 806, upon receiving the reverse search signal, the user device initiates a scan process to discover and identify nearby Bluetooth-connected devices. The user device collects device identifiers, signal strength indicators, and any available proximity data.

At step 808, the user device communicates the discovered device information back to the eyeglass via bi-directional Bluetooth communication, enabling the eyeglass to receive real-time data regarding surrounding devices.

At step 810, the eyeglass processes the received information and determines the relevant proximity or location information of the discovered devices. The eyeglass may relay this information to the user device for display, or trigger notifications to alert the user about the proximity or presence of specific devices.

At step 812, the process supports continuous or periodic reverse searches, allowing dynamic updates as devices move in and out of range, thus facilitating ongoing tracking and location management of multiple connected devices in real time.

The reverse search process enables enhanced device location capabilities by leveraging the processing and scanning abilities of the user device while empowering the eyeglass to actively coordinate discovery operations. This bidirectional data exchange mechanism improves overall system robustness, providing a flexible and efficient approach for locating and managing multiple Bluetooth-enabled devices in diverse environments.

FIG. 10 illustrates a flow diagram 900 of a tracking method for the eyeglass utilizing a smart home system. This method enables seamless integration between the eyeglass and smart home devices for locating and managing the eyeglass within a home or smart environment.

At step 902, the smart home system receives a command or trigger event to locate the eyeglass. This command may originate from a voice assistant (e.g., Alexa, Google Assistant), a mobile application linked to the smart home network, or an automated scheduling event.

At step 904, the smart home system transmits a locate request signal to the Bluetooth module 208 via the home's wireless communication protocol (e.g., Wi-Fi, Zigbee, or Bluetooth mesh).

At step 906, the eyeglass receives the locate request and activates its tracking module 402, including GPS and Ultra-Wideband (UWB) transceiver functionalities, to determine its current location and proximity relative to the smart home system or paired devices.

At step 908, the eyeglass transmits location data and proximity signals back to the smart home system, enabling the system to assess the eyeglass position within the home environment.

At step 910, the smart home system processes the location data and triggers a visual or audio alert within the smart home environment. For example, smart speakers may emit a sound, smart lights may flash, or a notification may be sent to the user's mobile device.

At step 912, the user receives the alert and follows the indications provided by the smart home system to locate the eyeglass. The system may provide augmented reality (AR) cues, directional guidance, or distance metrics via a connected display or mobile app.

At step 914, once the eyeglass is located, the smart home system receives confirmation from the user or the temple wire (e.g., via button press or proximity sensor) to conclude the tracking operation.

At step 916, the eyeglass returns to a low-power or sleep mode to conserve battery life, and the smart home system logs the tracking event for audit or user history purposes.

FIG. 11 depicts a flowchart 1000 illustrating a method for enabling, tracking, and managing shared location access of an eyeglass integrated with a tracking device.

At step 1002, the method begins with receiving, from a user device, a pairing request for the eyeglass, wherein the eyeglass includes a Bluetooth module, a GPS receiver, and an Ultra-Wideband (UWB) transceiver embedded within a housing. Upon receiving the pairing request, the method proceeds to step 1004, wherein a secure communication link is established between the eyeglass and a mobile application executing on the user's device via the Bluetooth module.

At step 1006, the method involves receiving and processing location and proximity data from the GPS receiver and the UWB transceiver embedded within the eyeglass. This data is utilized to determine the current or last known location of the eyeglass. Subsequently, at step 1008, the method includes displaying, on the mobile application, a visual notification of the eyeglass location without necessarily generating a navigation route, thereby providing the user with immediate awareness of the device's whereabouts.

At step 1010, the system monitors the communication link and triggers an alert on the user's device when the eyeglass is determined to be outside a predefined communication range, indicating potential misplacement or loss.

The method further includes an optional shared access management feature. At step 1012, the system receives an authorization input from a primary user to enable shared access of the eyeglass tracking data with one or more secondary users, wherein each secondary user is identified by account credentials. Following this, at step 1014, a sharing relationship is stored within a permissions database associating the eyeglass with both the primary and authorized secondary users.

At step 1016, the system authenticates any secondary user requesting location updates of the eyeglass, enforcing sharing parameters as defined by the primary user. These parameters may include time limitations, geographic constraints, or usage conditions. Further, at step 1018, the primary user is enabled to update or revoke access permissions of secondary users, with corresponding automatic updates to the permissions database to enforce such changes.

Integration with smart home systems is illustrated in step 1020, wherein the eyeglass pairs with a smart home system configured to send voice or digital commands to initiate location alerts or other tracking functions for the eyeglass.

At step 1022, the method allows for the definition of one or more exclusion zones by the user, wherein each exclusion zone comprises a geographic area defined by coordinates and boundary parameters. Finally, at step 1024, the system suppresses alerts when the eyeglass is detected within any of the user-defined exclusion zones, thus preventing false alarms in trusted or expected locations.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A system for tracking an eyeglass, the system comprising:
a communication module in the eyeglass configured to wirelessly communicate with a user device over a network, wherein the communication module operates on an encrypted communication protocol to prevent unauthorized access;
a tracking module in the eyeglass configured to determine a location data of the eyeglass;
a mobile application in the user device in communication with the communication module over the encrypted wireless network, the mobile application is configured to:
receive an input from a user defining one or more exclusion zones;
store the exclusion zone in association with a user account;
retrieve a current location of the eyeglass;
suppress a separation alert if the location is within an exclusion zone, and generate and transmit a separation alert if the location is outside all exclusion zones.

2. The system of claim 1, wherein the mobile application in the user device comprises a permission management subsystem configured to:
receive an authorization input from a primary user to share location access with a secondary user;
verify and store access credentials for the secondary user;
enforce access control rules based on the stored permissions; and
transmit tracking data to authorized users only.

3. The system of claim 1, wherein the mobile application is further configured to allow the user to modify, delete, or add exclusion zones in real-time, and dynamically applies the changes to the notification logic.

4. The system of claim 1, wherein the permissions management subsystem is configured to allow a primary user to set constraints for a secondary user including time-based access, geographic access limitations, or conditional usage rules.

5. The system of claim 1, wherein the tracking module includes at least one of a GPS receiver, UWB transceiver, inertial sensor, or Wi-Fi-based location system.

6. The system of claim 1, wherein the communication module is configured to operate over an encrypted wireless connection, and wherein the system prevents communication with unauthorized devices through encryption keys and authentication protocols.

7. The system of claim 1, further comprising a cloud-based server configured to store exclusion zones and permissions data, and to synchronize said data across multiple devices associated with the same user account.

8. A system for tracking an eyeglass, the system comprising:
a communication module in the eyeglass configured to wirelessly communicate with a user device over a network, wherein the communication module operates on an encrypted communication protocol to prevent unauthorized access;
a tracking module in the eyeglass configured to determine a location data of the eyeglass;
wherein the user device is configured to:
execute a mobile application for receiving input from a user;
receive signal data and the location data from the tracking module;
wherein the mobile application is configured to:
monitor co-location events between the eyeglass and an unregistered user device not associated with a registered owner of the eyeglass;
determine that the eyeglass has maintained repeated or prolonged proximity to the unregistered user device over a defined time period exceeding a tacking concern threshold;
generate a notification on the mobile application indicating potential unauthorized tracking by the unregistered user device.

9. The system of claim 8, wherein the mobile application in the user device generates and displays a navigational route to a current or last known location of the eyeglass based on the received location data.

10. The system of claim 8, wherein the tracking module includes at least one of a GPS receiver, a UWB transceiver, inertia sensor, or Wi-Fi based location service.

11. The system of claim 8, wherein the communication module is configured to pair with a smart home system to receive a command to initiate a location alert.

12. A system for tracking an eyeglass, the system comprising:
a temple wire configured to connect to an eyeglass frame, the temple wire comprising:
a housing;
a communication module embedded within the housing, the communication module configured to interface with a mobile application on a user device;
a tracking module embedded within the housing, wherein the tracking module is configured to transmit location and proximity signals to a mobile application executable on a user device;
wherein the mobile application is configured to:
display a visual notification of a last known or current location of the eyeglass; and
trigger an alert if the tracking module moves out of range.

13. The system of claim 12, wherein the temple wire is configured to pair with a smart home system to receive a command to initiate a location alert.

14. The system of claim 12, wherein the communication module includes at least Bluetooth, a Bluetooth Low energy, Wi-Fi, cellular mode, or a combination thereof.

15. The system of claim 12, wherein the tracking module includes at least a GPS, a UWB transceiver, GNSS, a location-based Wi-Fi, or a combination thereof.

16. The system of claim 15, wherein the UWB transceiver is configured to communicate with an external access system, wherein the eyeglass is operable to authenticate and unlock a secure entry point upon detection of proximity between the UWB transceiver and a corresponding UWB receiver integrated into the external access system.

17. The system of claim 16, wherein the unlock event is triggered based on predefined signal strength thresholds, spatial orientation, or motion patterns as determined by one or more sensors on the eyeglass.

18. The system of claim 12, wherein the housing further comprises a tamper detection module configured to initiate an alert on the user device upon unauthorized removal or manipulation of the housing.

19. The system of claim 12, wherein the eyeglass comprises a pair of temple wire, wherein the communication module in a first temple wire is configured to pair with a first tracking network on the user device, and the communication module in a second temple wire is configured to pair with a second tracking network on the user device.

20. The system of claim 19, wherein the first tracking network and the second tracking network comprise Apple Find My Device and Google Find My Device.
